(19) United States
(12) Patent Application Publication
(10) Pub. No.: US 2019/0104594 A1
(43) Pub. Date: Apr. 4, 2019

(54) LIGHT DEVICE FOR DEWAR

(71) Applicant: WORTHINGTON INDUSTRIES, INC., Columbus, OH (US)

(72) Inventors: CLIFF R. WALTERS, COLUMBUS, OH (US); JOHN L. ROMANOS, MOBILE, AL (US)

(21) Appl. No.: 16/141,242

(22) Filed: Sep. 25, 2018

Related U.S. Application Data
(60) Provisional application No. 62/566,920, filed on Oct. 2, 2017.

(51) Int. Cl. H05B 37/02; F21V 23/04; F21V 23/02; F21V 15/01

(52) U.S. Cl. CPC H05B 37/0209; F21V 15/01; F21V 23/023; F21V 23/04

(57) ABSTRACT

The invention described herein generally pertains to a system and method related to a light device that is configured to attach to a dewar, wherein the light device delivers a light to an inside of the dewar for inspection or examination. The light device can include a first base member that is positioned to mate with an outside sidewall of a rim surrounding an opening on the dewar, wherein an arm is moveable to position a light to shine into the opening.

### CROSS-REFERENCE(S) TO RELATED APPLICATIONS

This application claims priority to and the benefit of U.S. Provisional Application Ser. No. 62/566,920 filed on Oct. 2, 2017, the entirety of which is incorporated herein by reference.

### TECHNICAL FIELD

In general, the present invention relates to a cryogenic dewar and in particular a light device for a cryogenic dewar.

### BACKGROUND OF THE INVENTION

A dewar can be a vacuum flask used to store materials. Dewars can be in various shapes and forms such as, but not limited to, buckets, flasks with stoppers and self-pressurizing tanks. The dewar includes sidewalls with two or more layers in which a vacuum is maintained between the layers for thermal isolation between the interior and the exterior of the dewar.

### SUMMARY OF THE INVENTION

In accordance with an embodiment of the present invention, a light device is provided that includes at least the following: a base member having a top, a bottom opposite the top, a left side, a right side opposite the left side, a front, and a back opposite to the front; the front having a curved surface configured to contact an outside of a rim of a container; an attachment component that couples the base member to the rim of the container, the attachment component is integrated into the left side and the right side; a power supply; an arm having a first end and a second end opposite thereto, the arm is coupled to the top of the base member, the arm is moveable in at least one plane from a first position substantially parallel in relation to a plane of the rim of the container to a second position; a light positioned on the first end of the arm, wherein a portion of the first end and the light extend across the rim while in the first position to align the light to deliver light into an opening defined by the rim of the container; and a means for controlling delivery of power to the light.

According to one embodiment of the light device, the top of the base member includes a first leg and a second leg that couple to the second end of the arm with a hinge or a pin.

According to one embodiment of the light device, the means for controlling delivery of power is located on the base member.

According to one embodiment of the light device, the means for controlling delivery of power is located on the arm.

According to one embodiment of the light device, the light is positioned on a bottom side of the first end of arm.

According to one embodiment of the light device, the attachment component is a strap.

According to one embodiment of the light device, at least a portion of the strap comprises a hook and loop fastener.

According to one embodiment of the light device, the attachment component is at least partially elastic and is configured to be stretched over the rim.

According to one embodiment of the light device, the light is extendable from the arm.

In accordance with an embodiment of the present invention, a light device is provided that includes at least the following: a first base member and a second base member, each of the first base member and the second base member comprising a top, a bottom opposite the top, a left side, a right side opposite the left side, and a front having a curved surface configured to contact an outside of a rim of a container; a first arm and a second arm each having a first end and a second end opposite thereto, the first arm is coupled to the top of the first base member and the second arm is coupled to the top of the second base member, the first arm and second arm are each independently moveable in at least one plane from a first position substantially parallel in relation to a plane of the rim of the container to a second position; and a first light positioned on the first end of the first arm and a second light positioned on the first end of the second arm. A portion of the first end of the first arm, the first light, the first end of the second arm, and the second light extend across the rim while in the first position to align the first light and the second light to deliver light into an opening defined by the rim of the container.

According to one embodiment of the light device, the light device further includes an attachment component that couples the first base member and the second base member to the rim of the container.

According to one embodiment of the light device, the attachment component is a strap.

According to one embodiment of the light device, at least a portion of the strap comprises a hook and loop fastener.

According to one embodiment of the light device, the attachment component loops through at least one of the first base member or the second base member.

According to one embodiment of the light device, the front of the first base member, the front of the second base member, and the attachment component define a loop, wherein the first base member and the second base member are on opposing ends of the loop.

According to one embodiment of the light device, the light device further includes a power supply that provides power to the first light and the second light.

According to one embodiment of the light device, the light device further includes a first power supply that provides power to the first light, and a second power supply that provides power to the second light.

In accordance with an embodiment of the present invention, a system is provided that includes at least the following: a container having a rim that defines an opening; and a light device. The light device can include a base member having a top, a bottom opposite the top, a left side, a right side opposite the left side, a front, and a back opposite to the front; the front having a curved surface configured to contact an outside of the rim of the container; a power supply; an arm having a first end and a second end opposite thereto, the arm is coupled to the top of the base member, the arm is moveable in at least one plane from a first position substantially parallel in relation to a plane of the rim of the container to a second position; a light positioned on the first end of the arm, wherein a portion of the first end and the light extend across the rim while in the first position to align the light to deliver light into the opening of the container; and a means for controlling delivery of power to the light.

According to one embodiment of the system, the light device is integrated into the container.

According to one embodiment of the system, the container is a dewar.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a light device positioned on a rim of a dewar;

FIG. 2 illustrates a cryogenic dewar;

FIG. 3 illustrates a light device for a dewar;

FIG. 4 illustrates a top view of a light device positioned on an opening of a dewar;

FIG. 5 illustrates a side view of a light device;

FIG. 6 illustrates a top view of a light device;

FIG. 7 illustrates a top perspective view of a light device;

FIG. 8 illustrates a top perspective view of an embodiment of a light device;

FIG. 9 illustrates an embodiment of a light device

FIG. 10 illustrates an embodiment of a light device with a rear battery storage;

FIG. 11 illustrates a light device positioned on an opening of a dewar;

FIG. 12 illustrates a light device positioned on an opening of a dewar, wherein a lid for an opening of the dewar is removed;

### DETAILED DESCRIPTION OF THE INVENTION

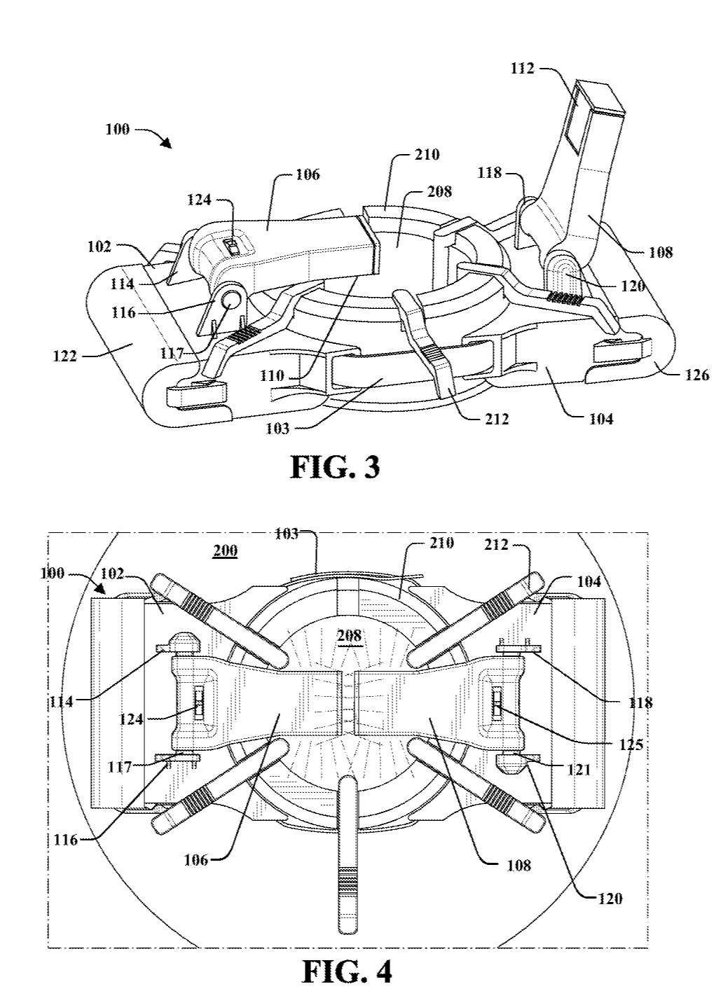

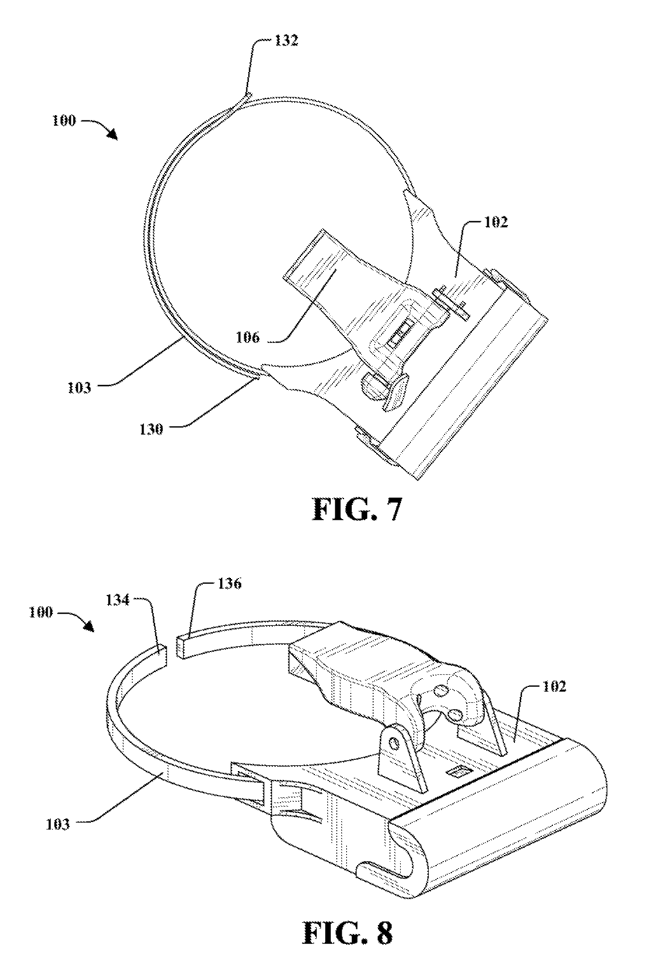

Embodiments of the invention relate to methods and systems that relate to a light device that can be removeably coupled to a rim that surrounds an opening on a dewar. An embodiment of the light device can include a single-base light device (e.g., illustrated in at least FIG. 7) or a two-base light device (e.g., illustrated in at least FIG. 3). The light device can be affixed to a rim that surrounds an opening of a dewar, wherein a light situated on an arm can be moveable to allow a light to be delivered to the opening of the dewar. The light device facilitates reading data or information contained within the inside of the dewar.

The subject application includes features of utility and ornamental design for a light device as described herein.

While the embodiments discussed herein have been related to the systems and methods discussed above, these embodiments are intended to be exemplary and are not intended to limit the applicability of these embodiments to only those discussions set forth herein. The embodiments and discussions herein can be readily incorporated into any of these systems and methodologies by those of skill in the art.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

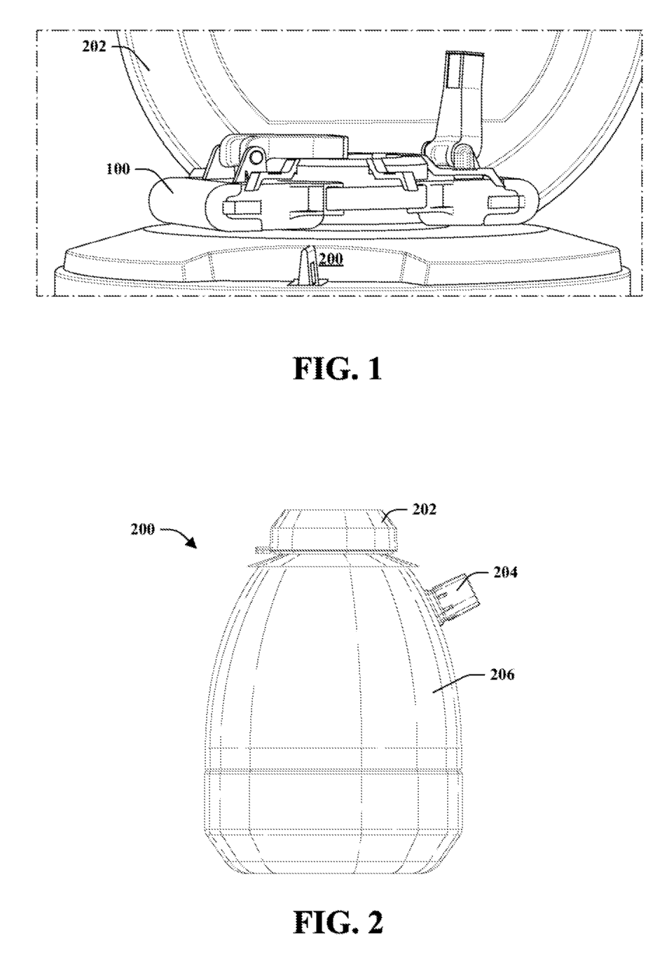

Turning to FIG. 1, a light device 100 is illustrated. The light device 100 can be coupled to a rim of a container such as a dewar 200. The rim of the dewar 200 surrounds an opening that is accessible by opening a first lid 202. It is to be appreciated that the opening of the dewar 200 can include a cap or other sealing device in addition to the first lid 202. The light device 100 can be removably affixed to the rim which allows a light to be delivered to an inside of the dewar 200 via the opening to which the rim surrounds. The light delivered allows a user to view inside the dewar 200, wherein data or other information may be printed or engraved on an inside of the dewar 200 (e.g., on an internal wall). The light delivered further allows a user to view contents of material stored or housed in the dewar 200. Throughout this disclosure, examples are presented that involve a dewar 200. However, it should be appreciated that the disclosed embodiments may be used with any appropriate container. The light device 100 can be employed, utilized, integrated, incorporated into, or removeably coupled to a container that holds a volume having an opening, wherein the light device can be employed, utilized, integrated, incorporated into, or removeably coupled to a portion of the opening or a rim or edge of the opening. It is to be appreciated that the container can be selected with sound engineering dependent without departing from the scope of the subject innovation. In an embodiment, the light device 100 can be integrated or incorporated into the dewar 200. In another embodiment, the light device 100 can be incorporated into a rim of the dewar or a stand-alone device that can be attached to the rim of the dewar, or a combination thereof (e.g., portions of the light device 100 incorporated into the rim of the dewar 200 and other portions being a stand-alone device that attach or rest on the rim of the dewar 200).

FIG. 2 illustrates the dewar 200. The dewar 200 can be a cryogenic dewar that is configured to house a sample that is dependent on a temperature range. The cryogenic dewar can be insulated for a temperature source to maintain one or more parameters so as to control the temperature range for the sample. By way of example and not limitation, the dewar 200 can include the temperature source of liquid nitrogen or liquid helium in which the temperature source is provided to maintain a temperature range colder than the ambient temperature or a temperature that is required or desired for a material stored in the dewar 200.

The dewar 200 can include a top, a bottom opposite the top, and a side wall 206 in between the top and the bottom. The dewar 200 can include one or more internal walls to provide insulation for a housing space. The dewar 200 can include a cap 202, a valve 204 (also referred to as an evacuation spud).

By way of example and not limitation, the sample can be at least one of a biological product, a biological specimen, a virus, bone marrow cells, semen, (e.g., animal semen, human semen, bull semen, canine semen, among others), cord blood cells, cultured human red blood cells containing the erythrocytic, dendrite cells, diluted lenti virus, E2A cells, genetically modified E. coli, human basophil cell, culture, human embryos, human fresh frozen tissue, human induciable hepatocytes, human mGluR2/HEK cells, human mGluR4/HEK cells, human neural cells, human semen, human serum, human urine, male dog hepatocytes, male reproductive tissue, master cell bank, mice embryos, PB eosinophils, PBMC; human white blood cells, PfMSP-1 antibody, rat hepatocytes, rat hybridoma cells, recombinant plasmid DNA, recumbent plant DNA, soil samples, stem cells, test media kits, standard and control primers, among others. It is to be appreciated that the container can house a sample with a temperature source such that the temperature source can be selected with sound engineering dependent upon the sample.

Turning to FIGS. 3 and 4, the light device 100 is illustrated in a perspective view (FIG. 3) and a top view (FIG. 4). The light device 100 can include a first base member 102 and a second base member 104. It is to be appreciated that in an embodiment, the light device 100 can include the first base member 102. It is further appreciated that in another embodiment, the light device 100 can include the first base member 102 and the second base member 104. In still another embodiment, the light device 100 can include two or more base members and respective components and features (described herein) and the subject innovation is not limited to a number of base members. The light device 100 can be removeably attached to a portion of the dewar 200 or permanently attached to a portion of the dewar 200.

The first base member 102 can have a top, bottom (opposite the top), left side, right side (opposite the left side), a front and a rear (opposite the front). The front of the first base member 102 can include a curved surface configured to mate and contact an outside sidewall of a rim 210 surrounding an opening 208 of the dewar 200. In an embodiment, the curved surface on the first base member 102 can be concave, among others. In such embodiment, the rim 210 can be curved such as a circular rim or an oval-shaped rim. The front of the first base member 102 can further include a first arm protruding from the left side and a second arm protruding from the right side to partially wrap-around the sidewall of the rim 210. The second base member 104 can have a top, bottom (opposite the top), left side, right side (opposite the left side), a front and a rear (opposite the front). The front of the second base member 104 can include a surface shaped to mate and/or contact an outside sidewall of the rim 210 surrounding the opening 208 of the dewar 200. By way of example and not limitation, the front of the second base member 104 can include a concave curved surface. The front of the second base member 104 can further include a first arm protruding from the left side and a second arm protruding from the right side to wrap-around the rim 210. It is to be appreciated that the first base member 102 can be positioned substantially opposite of the second base member 104 when positioned around the opening 208. The positioning and location of the first base member 102 and the second base member 104 can be selected with sound engineering without departing from the scope of the subject innovation. The light device 100 can include a height that allows the first base member 102 and the second base member 104 to fit under one or more ladle handles 212.

An attachment component 103 can be included with the light device 100, wherein the attachment component 103 is configured to facilitate attaching to the rim 210 of the dewar. In a particular embodiment for a single-base member light device, the attachment component 103 is a hook-and-loop strap. By way of example, the light device can include a first strap and a second strap, each strap having a first end and a second end opposite thereto. The first strap can have the first end coupled to the first arm and the second end coupled to the second end of the second strap. The first end of the second strap can be coupled to the second arm. In such example, a portion of the first strap and the second strap can be in contact with the outside sidewall of the rim 210. In a particular embodiment for a two-base member light device, the attachment component 103 can be a hook-and-loop strap that loops through the first base member 102 and the second base member 104, wherein a portion of the hook-and-loop strap is in contact with the outside sidewall of the rim 210. The attachment component 103, the concave curved surface of the first base member 102, and the concave curved surface of the second base member 104 can encircle the rim 210 of the dewar 200 for removeable attachment thereto.

The first base member 102 can include an arm 106, the arm 106 having a first end and a second end opposite the first end. The first end of the arm 106 can include a light 110. In certain embodiments, the light 110 is located at least partially on an underside of the arm 106. The light 110 can be, for example, an incandescent bulb, a light-emitting diode (LED) light, a solar powered light, a bulb having a filament, a fluorescent bulb, a halogen bulb, a neon bulb, a combination thereof, among others. In an embodiment, the light 110 can be at least partially enclosed by a transparent cap on the end of the arm 106, and any related electronic light components located inside of the arm 106. In another embodiment, the light 110 can be enclosed by a transparent cap completely on the end of the arm 106. In still another embodiment, the light 110 can be not enclosed by a transparent cap.

In an embodiment, the arm 106 can be attached to the top of the first base member 102. In another embodiment, the arm 106 can be attached to the first base member 102 at a location that is at least one of the top, rear, front, left side, right side, or a combination thereof. The arm 106 can be movable in at least one direction so as to allow the light 110 to deliver a light into the opening 208 of the dewar 200. By way of example and not limitation, the light 110 can deliver a portion of light in a direction to allow viewing into the dewar 200 via the opening 208. In particular, based on the dewar 200 on a ground level and having the opening 208 on a top portion of the dewar 200 (e.g., opposite the ground level), the light 110 can deliver the portion of light downward to the ground level into the opening 208. It should be appreciated that the light device 100 can also function in situations where the opening 208 is located in a side of a container. In an embodiment, the arm 106 is moveable in at least one plane from a substantially horizontal position to a substantially vertical position in relation to a plane of the rim 210 of the dewar 200, wherein the arm 106 in the substantially horizontal position allows the light 110 to deliver a light into the opening 208. For example, a first plane can be defined by the rim 210 in which the arm 106 is moveable from a position that is substantially parallel to the rim 210 and a position that is substantially vertical and perpendicular to the rim 210. It is to be appreciated that the position that is substantially parallel to the rim 210 can allow light to be delivered to the opening 208 from the light 110. It is to be appreciated that the position that is substantially vertical to the rim 210 positions the light device 100 to not obstruct the opening 208.

In an embodiment, the arm 106 can be attached to the top of the first base member 102 using a first leg 114 and a second leg 116 that couple to the second end of the arm 106 by way of a hinge or a pin 117. The first leg 114 and the second leg 116 can be configured to allow movement of the arm 106 by allowing the arm 106 to pivot about the hinge or pin 117 such that the arm 106 is moveable to a position where the first end having the light 110 allows a light to be delivered into the opening 208.

The first base member 102 can include a power supply 128. By way of example, the power supply 128 can be incorporated into the first base member 102. For instance, the power supply 128 can be a battery that is positioned inside the first base member 102 at a location having a battery access panel 122. In another embodiment, the power supply 128 can be a solar panel. In still another embodiment, the power supply can be a battery and a solar panel that contributes to supplementing power to the battery and/or the light device 100. In still another embodiment, the power supply 128 can be circuitry configured to receive power from a wall outlet and condition and provide that power to the light 110 or 112. The power supply 128 can include a cover or access panel 122 that can be removeably coupled to the first base member 102. The arm 106 can further include a power switch 124 that can be a two-positional switch in which a first position causes the power supply 128 to deliver power to the light 110 and a second position that turns off power delivery from the power supply 128. It should be appreciated that the power switch 124 can be a slider switch, a rocker switch, a pushbutton, a touchpad, a voice command module that is activated by audible sound, a fingerprint reading device, an image capture device that reads an eye or face, among others. The power switch 124 can also be located on the first base member 102, for example, on the top of the first base member 102. In certain embodiments, the power switch 124 can be incorporated into the light device 100 such that the light 110 automatically turns on when the arm 106 is in the horizontal position over the opening 208. The location of the power switch 124 can be selected with sound engineering judgment or position on or proximate to the light device 100 without departing from the scope of the subject innovation. In another embodiment, the power switch 124 can be incorporated into a portion of the light device 100 or a portion of the dewar 200 or a stand-alone component.

Similar to the first base member 102, the second base member 104 can include an arm 108, the arm 108 having a first end and a second end opposite the first end. The first end of the arm 108 can include a light 112. The disclosure with regards to the light 110, above, applies respectively to light 112 as well.

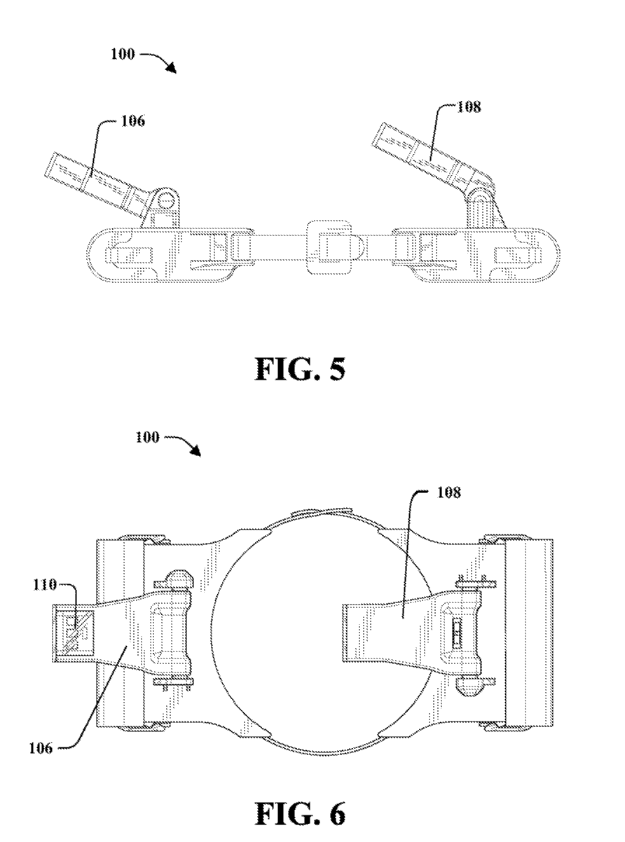

In an embodiment, the arm 108 can be attached to the top of the second base member 104. In another embodiment, the arm 108 can be attached to the second base member 104 at a location that is at least one of the top, rear, front, left side, right side, or a combination thereof. The arm 108 can be movable in at least one direction so as to allow the light 112 to deliver a light into the opening 208 of the dewar 200. In an embodiment, the arm 108 is moveable in at least one plane from a substantially horizontal position to a substantially vertical position in relation to a plane of the rim 210 of the dewar 200, wherein the arm 108 in the substantially horizontal position allows the light 112 to deliver a light into the opening 208. For example, a first plane can be defined by the rim 210 in which the arm 108 is moveable from a position that is substantially parallel to the rim 210 and a position that is substantially vertical and perpendicular to the rim 210 compared to a ground level when the dewar is on the ground level with the opening on the dewar being opposite to the ground level and the rim being parallel to the ground level. It is to be appreciated that the position that is substantially parallel to the rim 210 can allow light to be delivered to the opening 208 from the light 112. It is to be appreciated that the position that is substantially vertical and perpendicular to the rim 210 positions the light device 100 to not obstruct the opening 208. Either arm, 106 or 108, may also be pivoted into a position away from the opening 208, and past the vertical position, as shown by arm 106 in FIGS. 5-6.

In an embodiment, the arm 108 can be attached to the top of the second base member 104 using a first leg 118 and a second leg 120 that couple to the second end of the arm 108 by way of a hinge or a pin 121. The first leg 118 and the second leg 120 can be configured to allow movement of the arm 108 by allowing the arm 108 to pivot about the hinge or pin 121 such that the arm 108 is moveable to a position where the first end having the light 112 allows a light to be delivered into the opening 208.

The second base member 104 can include a power supply 128. By way of example, the power supply 128 can be incorporated into the second base member 104. For instance, the power supply 128 can be a battery that is positioned inside the first base member 104 at a location having a battery access panel 126. The power supply 128 can include a cover or access panel that can be removeably coupled to the second base member 104. The arm 108 can further include a power switch 125 that can be a two-positional switch in which a first position causes the power supply 128 to deliver power to the light 112 and a second position that turns off power delivery from the power supply. It should be appreciated that the power switch 125 can be a slider switch, a rocker switch, a pushbutton, a touchpad, a voice command module that is activated by audible sound, a fingerprint reading device, an image capture device that reads an eye or face, among others. In certain embodiments, the power switch 125 can be incorporated into the light device 100 such that the light 112 automatically turns on when the arm 108 is in the position parallel to the rim 210 over the opening 208. It should also be appreciated that the light 110 and the light 112 can share a power supply and/or a switch. The location of the power switch 125 can be selected with sound engineering judgment or position on or proximate to the light device 100 without departing from the scope of the subject innovation. In another embodiment, the power switch 125 can be incorporated into a portion of the light device 100 or a portion of the dewar 200 or a stand-alone component.

Turning now to FIGS. 7-8, the light device 100 can include the first base member 102 and the first base member's corresponding components. As shown in FIG. 7, the attachment component 103 can loop through the first base member 102 such that the first end 130 and/or second end 132 of the attachment component 103 attaches to a portion of the attachment component 103 to close the loop. The loop created by the attachment component 103 and the front surface of the first base member 102 can encircle the rim 210 of the dewar 200. It should be further appreciated that the attachment component 103 can be a strap made of any material such as a nylon, a hook-and-loop fastener, elastic, rubber, leather, among others. The first 130 and/or second ends 132 of the attachment component 103 can couple together or to a portion of the attachment component 103 using the hook-and-loop fastener, a snap, a buckle, among others. Connection pieces can be chosen using sound engineering judgment. In certain embodiments, the attachment component can be a ridged or semi-rigid plastic strap, which can be adjustable by way of a locking mechanism that can be manually adjusted or adjusted using a turn-wheel. In an embodiment shown in FIG. 8, the attachment component is made of a rigid or semi-rigid material such as plastic. The first end 134 and the second end 136 of the attachment component 103 are not connected, but are separated by a gap. The first end 134 and second end 136 can be flexed outwardly and placed over the rim 210 of the dewar 200. The first end 134 and second end 136 can be released, allowing the first end 134 and the second end 136 to flex inwardly which secures the attachment component 103 in place on the rim 210. In this embodiment, the attachment component can be one continuous piece that loops through the first base member 102, or it can be two separate pieces with each piece attached to the first base member 102 at an end.

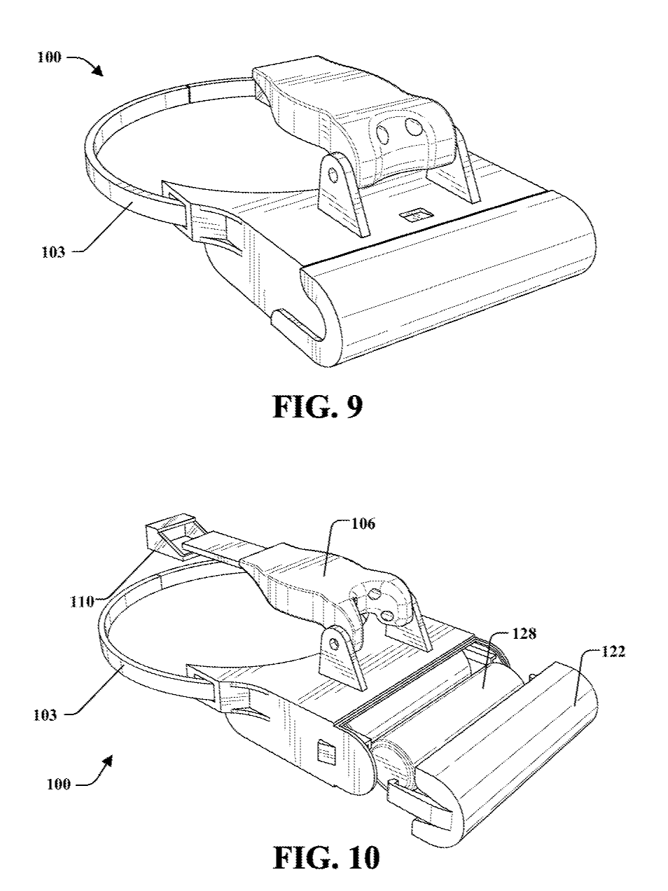

FIG. 9 illustrates a perspective view of another embodiment of the light device 100. In this embodiment, the attachment component 103 is a continuous piece without a gap. In this embodiment, the attachment component 103 can be made of a stretchable or elastic material such as rubber or elastic. The attachment component 103 can be at least partially elastic and is configured to be stretched over the rim 210 of the dewar 200 and secured in place on the rim 210. In this embodiment, the attachment component 103 is an enclosed loop with no ends.

FIG. 10 illustrates a perspective view of the light device 100 having a battery access panel 122, with the power supply 128 (in this example, a battery) exposed. In one embodiment, the battery access panel 122 is removeably attached to the first base member 102 by way of clips extending from the sides of the battery access panel 122. In other embodiments, the battery access panel 122 can include a hinge coupled to the first base member 102 and/or may be snapped close with a friction fit, one or more latches, or one or more snaps. In an example, a user may remove the battery access panel 122 to install or replace the power supply 128 (e.g. one or more batteries) that provides power to the light 110. Certain embodiments of the light device 100 further include a light 110 that is extendable and/or retractable. Light 110 can extend outwards by sliding away from arm 106, and can retract by sliding into arm 106. The light 110 can extend from a first position to a second position that is a first distance from the first position. The light can extend further to a third position that is a second distance from the first position, where the second distance is greater than the first distance. Extension and retraction of the light 110 can be accomplished manually by a user or automatically by the light device 100. In this manner, the position of the light 110 shining into the opening 208 of the dewar 200 can be adjusted along a diameter of the opening 208.

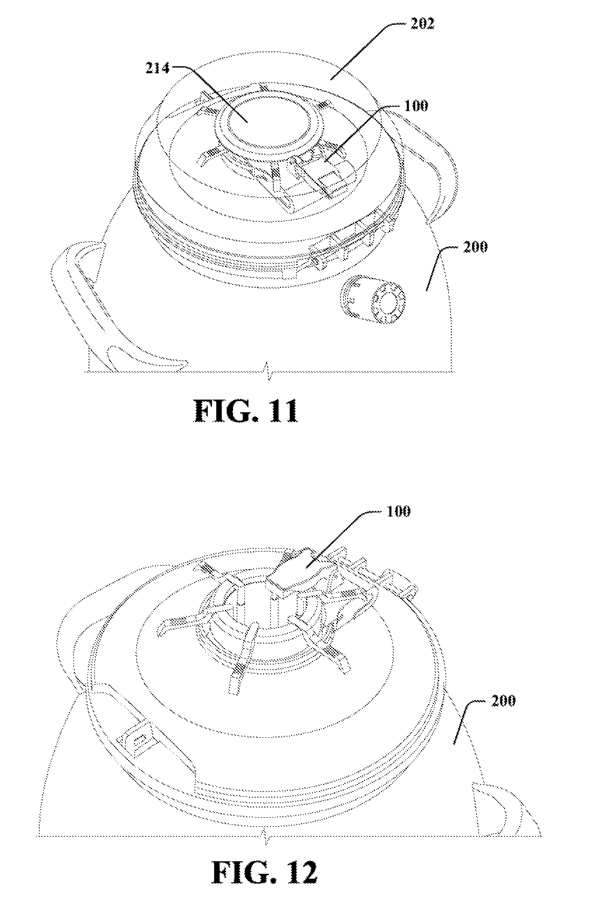

When the arm 106 is pivoted upwards, away from the opening 208 of the dewar 200, the arm 106 can be positioned in a vertical position (perpendicular to the rim 210) or pivoted past the perpendicular position as shown in FIG. 11, such that the underside of the arm 106 and the light 110 are facing upwards, or away from the dewar 200. When the arm 106 is pivoted into this position as to not obstruct the opening 208, a cap 214 can be placed on top of the rim 210 to cover the opening 208 while the light device 100 is still coupled with the rim 210 of the dewar 200. While in this position, the light device 100 has a height that is less than a clearance required by a first lid 202 to be placed and secured over the cap 214 and the light device 100 to enclose the top portion of the dewar 200.

FIG. 12 illustrates the light device 100 attached to an opening 208 of the dewar 200 with the first lid 202 and the cap 214 of the dewar removed. A user can pivot the arm 106 inwards towards the opening 208 such that the arm is in a position parallel to the rim 210 and the light 110 is facing into the opening 208.

In an embodiment, a camera can be included on the first end of the arm 106 or the first end of the arm 108 along with the light 110 or 112. In a particular embodiment, the camera can capture an image of an inside of the dewar 200. In another embodiment, a monitoring component can be configured to capture an image with the camera based on a parameter, wherein the parameter is a duration of time, a time, a date, a detected motion, a detected temperature, a detected pressure, a threshold for a pressure, a threshold for a temperature, a signal received from a device, a signal transmitted by a user, a user request, among others. In one embodiment, the lid 214 can have an access door or an access window to allow the camera to take pictures or monitor contents. In one example, the camera can be automated to extend over the lid and take pictures of the contents inside the dewar 200 at a regular time interval or based on receipt of a remote signal. The camera and light 110 can be configured to operate simultaneously as to provide a clear and illuminated view of the dewar 200 contents. Light device 100 can store image data from the camera locally or it can transmit the image data to another device. Such communication can be through a wired or a wireless data connection.

The aforementioned systems, containers, assemblies, features, elements, components, (e.g., light device 100, first base member 102, second base member 104, arm 106, arm 108, light 110, light 110, attachment component 103, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

In view of the exemplary devices and elements described supra, methodologies that may be implemented with the subject matter are included herein. In an embodiment, a method of attaching the light device 100 to a dewar is provided. A user can use attachment component 103 to attach the light device 100 to a dewar 200. For example, the user can stretch the attachment component 103 over the rim 210 of the dewar 200, or the user can extend the two ends of the attachment component 103 around the rim 210 of the dewar 200 and connect the first and/or second end of the attachment component 103 to a portion of the attachment component 103.

In another embodiment, a method of fabricated the light device 100 is provided. Each component of the light device 100 can be fabricated from a plastic, metal, or any other material selected using sound engineering judgment. Attachment component 103 can be inserted through the base member 102, or the attachment component 103 can be coupled to one or both sides of the base member 102. In embodiments having a first base member 102 and a second base member 104, the attachment component can be inserted through both base members 102, 104, or the attachment component 103 can be coupled to one or both sides of at least one of first base member 102 and second base member 104.

In an embodiment, a method of detaching the light device 100 from a dewar is provided. Attachment component 103 can be stretched and lifted/removed from the rim 210 of the dewar 200. In another embodiment, a user can detach the first or second end of the attachment component 103 from the attachment component 103 so that the light device 100 can be removed from the rim 210 of the dewar 200.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (sensors, assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A light device, comprising:
a base member having a top, a bottom opposite the top, a left side, a right side opposite the left side, a front, and a back opposite to the front;
the front having a curved surface configured to contact an outside of a rim of a container;
an attachment component that couples the base member to the rim of the container;
a power supply;
an arm having a first end and a second end opposite thereto, the arm is coupled to the top of the base member, the arm is moveable in at least one plane from a first position substantially parallel in relation to a plane of the rim of the container to a second position;
a light positioned on the first end of the arm, wherein a portion of the first end and the light extend across the rim while in the first position to align the light to deliver light into an opening defined by the rim of the container; and
a means for controlling delivery of power to the light.

2. The light device of claim 1, wherein the top of the base member comprises a first leg and a second leg that couple to the second end of the arm with a hinge or a pin.

3. The light device of claim 1, wherein the means for controlling delivery of power is located on the base member.

4. The light device of claim 1, wherein the means for controlling delivery of power is located on the arm.

5. The light device of claim 1, wherein the light is positioned on a bottom side of the first end of arm.

6. The light device of claim 1, wherein the attachment component is a strap.

7. The light device of claim 6, wherein at least a portion of the strap comprises a hook and loop fastener.

8. The light device of claim 1, wherein the attachment component is at least partially elastic and is configured to be stretched over the rim.

9. The light device of claim 1, wherein the light is extendable from the arm.

10. A light device comprising:
a first base member and a second base member, each of the first base member and the second base member comprising a top, a bottom opposite the top, a left side, a right side opposite the left side, and a front having a curved surface configured to contact an outside of a rim of a container;
a first arm and a second arm each having a first end and a second end opposite thereto, the first arm is coupled to the top of the first base member and the second arm is coupled to the top of the second base member, the first arm and second arm are each independently moveable in at least one plane from a first position substantially parallel in relation to a plane of the rim of the container to a second position; and
a first light positioned on the first end of the first arm and a second light positioned on the first end of the second arm, wherein a portion of the first end of the first arm, the first light, the first end of the second arm, and the second light extend across the rim while in the first position to align the first light and the second light to deliver light into an opening defined by the rim of the container.

11. The light device of claim 10, further comprising an attachment component that couples the first base member and the second base member to the rim of the container.

12. The light device of claim 11, wherein the attachment component is a strap.

13. The light device of claim 12, wherein at least a portion of the strap comprises a hook and loop fastener.

14. The light device of claim 11, wherein the attachment component loops through at least one of the first base member or the second base member.

15. The light device of claim 11, wherein the front of the first base member, the front of the second base member, and the attachment component define a loop, wherein the first base member and the second base member are on opposing ends of the loop.

16. The light device of claim 10, further comprising a power supply that provides power to the first light and the second light.

17. The light device of claim 10, further comprising:
a first power supply that provides power to the first light; and
a second power supply that provides power to the second light.

18. A system comprising:
a container having a rim that defines an opening; and
a light device comprising:
a base member having a top, a bottom opposite the top, a left side, a right side opposite the left side, a front, and a back opposite to the front;
the front having a curved surface configured to contact an outside of the rim of the container;
a power supply;
an arm having a first end and a second end opposite thereto, the arm is coupled to the top of the base member, the arm is moveable in at least one plane from a first position substantially parallel in relation to a plane of the rim of the container to a second position;
a light positioned on the first end of the arm, wherein a portion of the first end and the light extend across the rim while in the first position to align the light to deliver light into the opening of the container; and
a means for controlling delivery of power to the light.

19. The system of claim 18, wherein the light device is integrated into the container.

20. The system of claim 18, wherein the container is a dewar.
